(19) United States
(12) Patent Application Publication
(10) Pub. No.: US 2023/0063215 A1
(43) Pub. Date: Mar. 2, 2023

(54) INFORMATION PROCESSING APPARATUS, INFORMATION PROCESSING METHOD, AND PROGRAM

(71) Applicant: SONY GROUP CORPORATION, Tokyo (JP)

(72) Inventor: Akshat KADAM, Tokyo (JP)

(73) Assignee: SONY GROUP CORPORATION, Tokyo (JP)

(21) Appl. No.: 17/793,235

(22) PCT Filed: Jan. 12, 2021
(86) PCT No.: PCT/JP2021/000599

§ 371 Date: Jul. 15, 2022

(30) Foreign Application Priority Data
Jan. 23, 2020 (JP) 2020-008905

(51) Int. Cl. G06T 15/60; G06T 15/20

(52) U.S. Cl. CPC G06T 15/60; G06T 15/20

(57) ABSTRACT

A free viewpoint video generation unit (24) (generation unit) of an information processing apparatus (10a) generates a free viewpoint video (J) for viewing a 3D model (90M) (3D object) superimposed on background information (92) from an arbitrary viewpoint position. Then, a shadow application unit (27) generates a shadow (94) of a light source generated on the 3D model (90M) according to the viewpoint position based on light source information (93) indicating the position of the light source related to the background information (92) and the direction of the light beam emitted by the light source, depth information (D) (three-dimensional information) of the 3D model (90M), and the viewpoint position, and applies the generated shadow to the free viewpoint video (J).

### FIELD

The present disclosure relates to an information processing apparatus, an information processing method, and a program, and more particularly, to an information processing apparatus, an information processing method, and a program capable of applying a shadow of a 3D object according to a viewpoint position to a video (free viewpoint video) obtained by observing the 3D object, that is, a subject from a free viewpoint.

### BACKGROUND

Conventionally, there has been proposed a technique in which, when a three-dimensional model (hereinafter referred to as a 3D model) of a subject observed from a free viewpoint is transmitted to a replay device, the 3D model of the subject and a shadow of the subject are separately transmitted, and when the replay device replays the 3D model, the presence or absence of the shadow is selected (for example, Patent Literature 1).

### CITATION LIST

### Patent Literature

Patent Literature 1: WO 2019/031259 A

### SUMMARY

### Technical Problem

However, in Patent Literature 1, when a shadow is applied on the replay side, control is not performed to apply a shadow generated on a 3D model by an arbitrary light source without unnaturalness.

The present disclosure proposes an information processing apparatus, an information processing method, and a program capable of applying a shadow of a 3D object according to a viewpoint position to a free viewpoint video obtained by observing the 3D object from a free viewpoint.

### Solution to Problem

To solve the problems described above, an information processing apparatus according to an embodiment of the present disclosure includes: a generation unit that generates a free viewpoint video in which a 3D object superimposed on background information is viewed from a viewpoint position that is arbitrary; and a shadow application unit that generates a shadow generated on the 3D object according to the viewpoint position by a light source based on light source information indicating a position of the light source related to the background information and a direction of a light beam emitted by the light source, three-dimensional information of the 3D object, and the viewpoint position, and applies the shadow generated to the free viewpoint video.

### BRIEF DESCRIPTION OF DRAWINGS

FIG. 1 is a diagram illustrating an outline of a flow of processing of generating a 3D model.

FIG. 2 is a diagram illustrating contents of data necessary for representing a 3D model.

FIG. 3 is a diagram illustrating a method for generating a free viewpoint video obtained by observing a 3D model from a free viewpoint.

FIG. 4 is a hardware block diagram illustrating an example of a hardware configuration of an information processing apparatus according to a first embodiment.

FIG. 5 is a functional block diagram illustrating an example of a functional configuration of the information processing apparatus according to the first embodiment.

FIG. 6 is a diagram illustrating a method in which the information processing apparatus according to the first embodiment applies a shadow to a 3D model.

FIG. 7 is a diagram illustrating an example of a shadow applied to a 3D model by the information processing apparatus according to the first embodiment.

FIG. 8 is a diagram for explaining a flow of processing in which the information processing apparatus according to the first embodiment applies a shadow to a 3D model.

FIG. 9 is a flowchart illustrating an example of a flow of processing performed by the information processing apparatus according to the first embodiment.

FIG. 10 is a diagram for explaining a specific example of time freeze.

FIG. 11 is a diagram illustrating an example of a table used for shadow intensity control when an information processing apparatus according to a second embodiment performs time freeze.

FIG. 12 is a functional block diagram illustrating an example of a functional configuration of the information processing apparatus according to the second embodiment.

FIG. 13 is a flowchart illustrating an example of a flow of processing when the information processing apparatus according to the second embodiment applies a shadow.

FIG. 14 is a diagram illustrating an example of a free viewpoint video in which background information changes in a third embodiment.

### DESCRIPTION OF EMBODIMENTS

Hereinafter, embodiments of the present disclosure will be described in detail with reference to the drawings. Note that, in each of the following embodiments, the same parts are denoted by the same reference numerals, and redundant description will be omitted.

In addition, the present disclosure will be described according to the following item order.

1. First Embodiment

1-1. Explanation of Premise—Generation of 3D Model

1-2. Explanation of Premise—Data Structure of 3D Model

1-3. Explanation of Premise—Generation of Free Viewpoint Video

1-4. Description of Hardware Configuration of Information Processing Apparatus According to First Embodiment

1-5. Description of Functional Configuration of Information Processing Apparatus According to First Embodiment

1-6. Description of Shadow Application Method

1-7. Description of Shadow Application Processing

1-8. Description of Flow of Processing Performed by Information Processing Apparatus of First Embodiment

1-9. Effects of First Embodiment

2. Second Embodiment

2-1. Description of Time Freeze

2-2. Description of Shadow Intensity Control

2-3. Description of Functional Configuration of Information Processing Apparatus According to Second Embodiment

2-4. Description of Flow of Processing Performed by Information Processing Apparatus of Second Embodiment

2-5. Effects of Second Embodiment

3. Third Embodiment

3-1. Description of Free Viewpoint Video in which Background Information Changes.

3-2. Effects of Third Embodiment

### 1. First Embodiment

Before describing an information processing apparatus 10a according to a first embodiment of the present disclosure, processing of generating a 3D model of a subject will be described.

[1-1. Explanation of Premise—Generation of 3D Model]

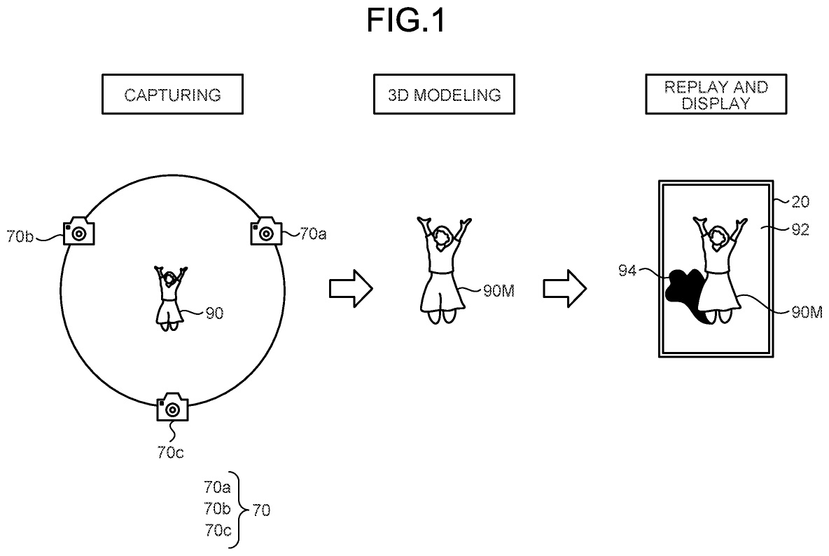

FIG. 1 is a diagram illustrating an outline of a flow of processing of generating a 3D model. As illustrated in FIG. 1, the generation of the 3D model includes capturing of a subject 90 by a plurality of imaging devices 70 (70a, 70b, 70c) and 3D modeling for generating a 3D model 90M having 3D information of the subject 90. Note that although three imaging devices 70 are illustrated in FIG. 1, the number of imaging devices 70 is not limited to three.

As illustrated in FIG. 1, the plurality of imaging devices 70 are arranged outside the subject 90 to face the subject 90 so as to surround the subject 90 existing in the real world. FIG. 1 illustrates an example in which the number of imaging devices is three, and the three imaging devices 70 are arranged around the subject 90. Note that, in FIG. 1, a person who performs a predetermined action is the subject 90.

3D modeling is performed using a plurality of images captured by Volumetric capture in synchronization from different viewpoints by the three imaging devices 70, and the 3D model 90M of the subject 90 is generated in units of video frames of the three imaging devices 70. Note that the Volumetric capture is to acquire information including both the texture and the depth (distance) of the subject 90.

The 3D model 90M is a model having 3D information of the subject 90. Note that the 3D model 90M is an example of a 3D object in the present disclosure. The 3D model 90M includes mesh data called polygon mesh in which geometry information of the subject 90 is expressed by connection between vertices and vertices, and texture information and depth information (distance information) corresponding to each polygon mesh. Note that the information included in the 3D model 90M is not limited thereto, and may include other information. Note that the depth information of the subject 90 is calculated, for example, from the images captured by the plurality of imaging devices 70 adjacent to each other based on the parallax related to the same region of the subject 90. Note that a sensor including a distance measuring mechanism such as a time of flight (ToF) camera may be installed in the vicinity of the imaging device 70, and the depth information may be obtained by measuring the distance to the subject 90 by the sensor. Note that the 3D model 90M may be an artificial model generated by computer graphics (CG).

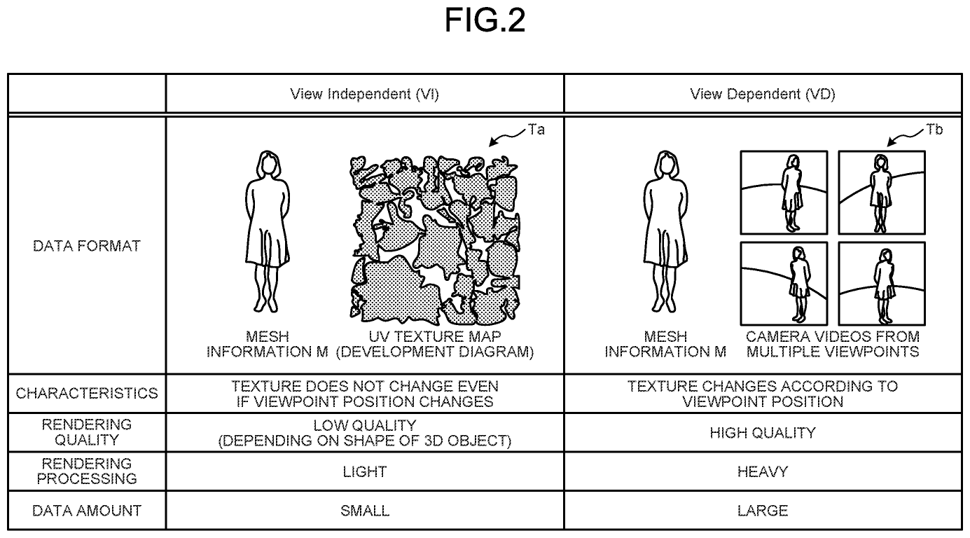

The 3D model 90M is subjected to so-called texture mapping in which a texture representing the color, pattern, or texture of the mesh is pasted according to the mesh position. In the texture mapping, it is desirable to paste a (view dependent) texture according to the viewpoint position in order to improve the reality of the 3D model 90M. As a result, when the 3D model 90M is captured from an arbitrary viewpoint (hereinafter referred to as a free viewpoint), the texture changes according to the viewpoint position, so that a higher-quality free viewpoint video can be generated. However, since the amount of calculation increases, a (view independent) texture that does not depend on the line-of-sight position may be pasted to the 3D model 90M. The data structure of the 3D model 90M will be described later in detail (see FIG. 2).

Note that the 3D model 90M may be expressed in a form called point cloud information (point cloud). The point cloud describes the subject 90 as a plurality of pieces of point cloud information forming the surface of the subject 90. Since each point forming the point cloud has color information and luminance information, the 3D model 90M described by the point cloud includes shape information and texture information of the subject 90.

The content data including the read 3D model 90M is transmitted to the device on the replay side. Then, the 3D model 90M is rendered in the device on the replay side, and the content data including the 3D model 90M is replayed.

As the device on the replay side, for example, a mobile terminal 20 such as a smartphone or a tablet terminal is used. Then, an image including the 3D model 90M is displayed on the display screen of the mobile terminal 20. Note that the information processing apparatus 10a itself may have a function of replaying the content data.

When the content data is replayed, the 3D model 90M is generally displayed in superposition with background information 92. The background information 92 may be a video captured in an environment different from that of the subject 90, or may be a CG.

The background information 92 is generally captured under a lighting environment. Therefore, in order to make the replayed video more natural, a shadow 94 generated by the lighting environment is also applied to the 3D model 90M superimposed on the background information 92. The information processing apparatus 10a applies the shadow 94 generated on the 3D model 90M according to the position of the free viewpoint based on the information related to lighting of the background information 92 (for example, light source information including a position of a light source and a lighting direction (a direction of a light beam)). Details will be described later. Note that the shadow 94 has a shape corresponding to the form of the 3D model 90M, but for the sake of simplicity, the illustrated shape of the shadow 94 is all simplified.

[1-2. Explanation of Premise—Data Structure of 3D Model]

Next, contents of data necessary for representing the 3D model 90M will be described with reference to FIG. 2. FIG. 2 is a diagram for explaining the contents of data necessary for representing the 3D model.

The 3D model 90M of the subject 90 is expressed by mesh information M indicating the shape of the subject 90, depth information D indicating the 3D shape of the subject 90, and texture information T indicating the texture (hue, pattern, etc.) of the surface of the subject 90.

The mesh information M represents the shape of the 3D model 90M by connecting some parts on the surface of the 3D model 90M as vertices (polygon mesh). The depth information D is information indicating the distance from the viewpoint position for observing the subject 90 to the surface of the subject 90. The depth information D of the subject 90 is calculated based on, for example, the parallax of the same region of the subject 90 detected from images captured by adjacent imaging devices. Note that the depth information D is an example of three-dimensional information in the present disclosure.

In the present embodiment, two types of data are used as the texture information T. One is (VI) texture information Ta that does not depend on the viewpoint position from which the 3D model 90M is observed. The texture information Ta is data in which the texture of the surface of the 3D model 90M is stored in the form of a development diagram like the UV texture map illustrated in FIG. 2, for example. That is, the texture information Ta is data that does not depend on the viewpoint position. For example, in a case where the 3D model 90M is a person wearing clothing, a UV texture map representing the pattern of the clothing is prepared as the texture information Ta. Then, the 3D model 90M can be drawn by pasting the texture information Ta (VI rendering) on the surface of the mesh information M representing the 3D model 90M. Then, at this time, even when the viewpoint position for viewing the 3D model 90M changes, the same texture information Ta is pasted to the mesh representing the same region. As described above, the VI rendering using the texture information Ta is performed by pasting the texture information Ta of the clothing worn by the 3D model 90M to all the meshes representing the parts of the clothing. Therefore, the data size is generally small, and the calculation load of the rendering processing is also light. However, since the pasted texture information Ta is uniform and the texture does not change even if the observed position (viewing position) is changed, the quality of the texture is generally low.

The other piece of texture information T is (VD) texture information Tb that depends on the viewpoint position at which the 3D model 90M is observed. The texture information Tb is expressed by a set of images obtained by observing the subject 90 from multiple viewpoints. That is, the texture information Ta is data corresponding to the viewpoint position. Specifically, in a case where the subject 90 is observed by N imaging devices 70, the texture information Tb is expressed by N images simultaneously captured by each imaging device 70. Then, in a case where the texture information Tb is rendered in an arbitrary mesh of the 3D model 90M, all the regions corresponding to the corresponding mesh are detected from the N images. Then, the texture captured in each of the plurality of detected regions is weighted and pasted to the corresponding mesh. As described above, the VD rendering using the texture information Tb generally has a large data size, and the calculation load of the rendering processing is heavy. However, since the pasted texture information Tb changes according to the viewpoint position, the quality of the texture is generally high.

The subject 90 on which the 3D model 90M is based generally moves with time. Therefore, the generated 3D model 90M also changes with time. That is, the mesh information M, the texture information Ta, and the texture information Tb described above generally form time-series data that changes with time.

[1-3. Explanation of Premise—Generation of Free Viewpoint Video]

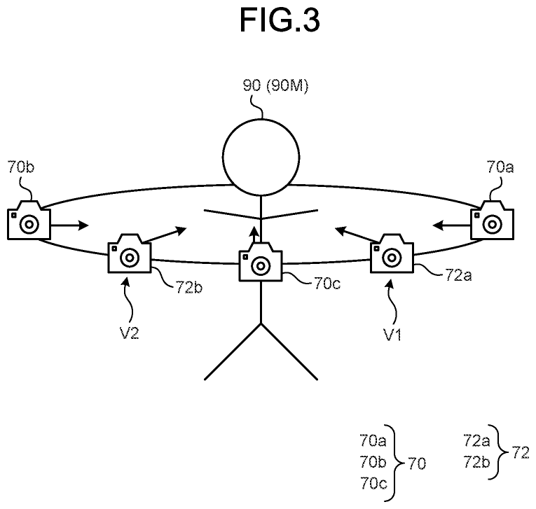

FIG. 3 is a diagram illustrating a method for generating a free viewpoint video obtained by observing a 3D model from a free viewpoint. In FIG. 3, the imaging device 70 (70a, 70b, 70c) is an imaging device used to create the 3D model 90M of the subject 90. In various applications using the 3D model 90M, it is desirable that the generated 3D model 90M can be replayed from as various directions as possible. Therefore, the information processing apparatus 10a generates a free viewpoint video obtained by observing the 3D model 90M from a position (free viewpoint) different from that of the imaging device 70.

For example, in FIG. 3, it is assumed that a free viewpoint video J1 (not illustrated) obtained when a virtual camera 72a placed at a free viewpoint V1 captures the 3D model 90M is generated. The free viewpoint video J1 is generated by interpolating images of the 3D model 90M captured by the imaging device 70a and the imaging device 70c placed in the vicinity of the virtual camera 72a. That is, the depth information D of the subject 90 is calculated by associating the image of the 3D model 90M captured by the imaging device 70a with the image of the 3D model 90M captured by the imaging device 70c. Then, by projecting the texture of the region corresponding to the calculated depth information D onto the virtual camera 72a, the free viewpoint video J1 of the 3D model 90M (subject 90) viewed from the virtual camera 72a can be generated.

Similarly, a free viewpoint video J2 (not illustrated) of the 3D model 90M viewed from a virtual camera 72b placed at a free viewpoint V2 in the vicinity of the imaging device 70b and the imaging device 70c can be generated by interpolating the image of the 3D model 90M captured by the imaging device 70b and the image of the 3D model 90M captured by the imaging device 70c. Hereinafter, the virtual cameras 72a and 72b are collectively referred to as a virtual camera 72. In addition, the free viewpoints V1 and V2 are collectively referred to as a free viewpoint V, and the free viewpoint videos J1 and J2 are collectively referred to as a free viewpoint video J. Note that, in FIG. 3, for the sake of explanation, the imaging device 70 and the virtual camera 72 are drawn with the back facing the subject 90, but are actually installed facing the direction of the arrow, that is, the direction of the subject 90.

Using such a free viewpoint video J enables effective video representation represented by time freeze, for example.

Time freeze is a video representation in which the lapse of time is stopped (frozen) during replay of a series of movements of the 3D model 90M (subject 90), and the 3D model 90M is continuously replayed from different free viewpoints in a state where the 3D model 90M is stationary.

The information processing apparatus 10a superimposes the background information 92 and the 3D model 90M to generate the free viewpoint video J observed from the free viewpoint V. Note that the background information 92 may be changed during replay of the free viewpoint video J.

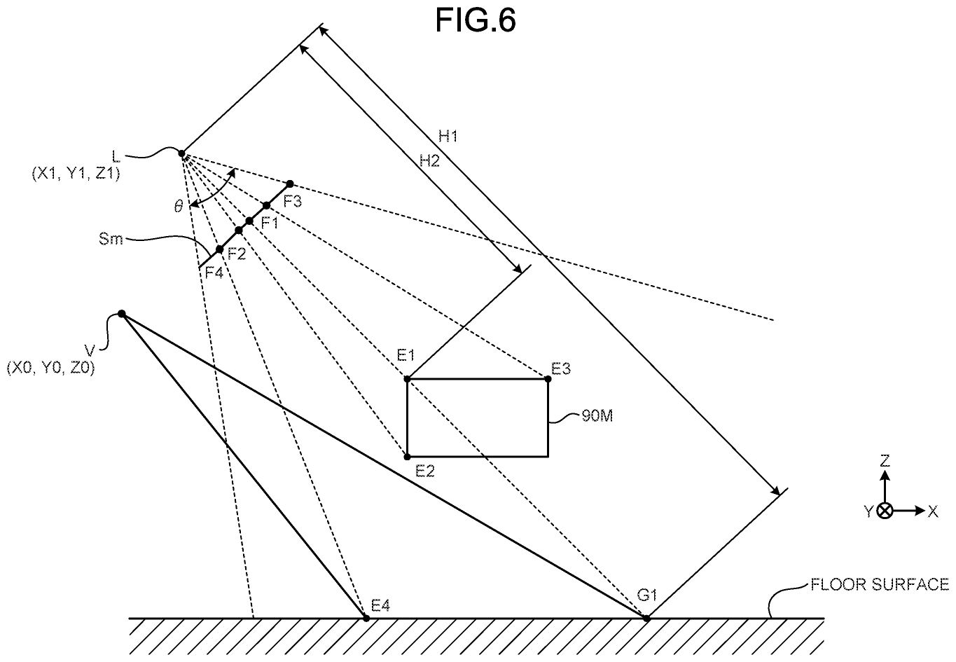

The 3D model 90M of the subject 90 does not have information on the shadow generated on the subject 90. Therefore, the information processing apparatus 10a applies a shadow corresponding to the free viewpoint V to the 3D model 90M superimposed on the background information 92 based on the light source information related to the background information 92. Details will be described later (see FIG. 6).

[1-4. Description of Hardware Configuration of Information Processing Apparatus According to First Embodiment]

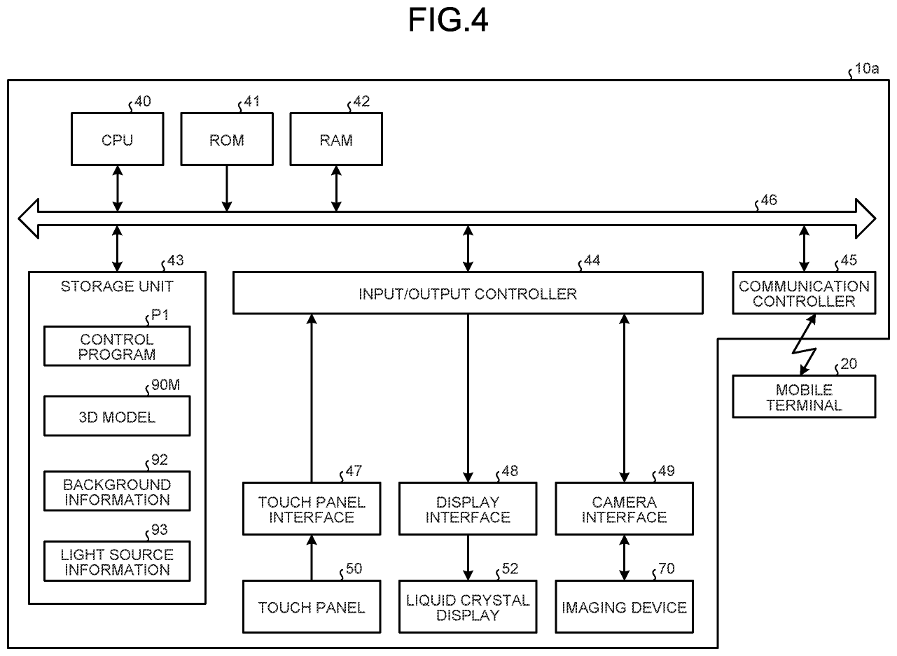

Next, a hardware configuration of the information processing apparatus 10a will be described with reference to FIG. 4. FIG. 4 is a hardware block diagram illustrating an example of a hardware configuration of the information processing apparatus according to the first embodiment.

The information processing apparatus 10a has a configuration in which a central processing unit (CPU) 40, a read only memory (ROM) 41, a random access memory (RAM) 42, a storage unit 43, an input/output controller 44, and a communication controller 45 are connected by an internal bus 46.

The CPU 40 develops and executes a control program P1 stored in the storage unit 43 and various data such as camera parameters stored in the ROM 41 on the RAM 42, thereby controlling the overall operation of the information processing apparatus 10a. That is, the information processing apparatus 10a has a configuration of a general computer that operates by the control program P1. Note that the control program P1 may be provided via a wired or wireless transmission medium such as a local area network, the Internet, or digital satellite broadcasting. In addition, the information processing apparatus 10a may perform a series of processing by hardware. Note that the control program P1 executed by the CPU 40 may be a program in which processing is performed in time series in the order described in the present disclosure, or may be a program in which processing is performed in parallel or at necessary timing such as when a call is made.

The storage unit 43 includes, for example, a storage device such as a flash memory in which stored information is held even when the power is turned off, and stores the control program P1 executed by the CPU 40, the 3D model 90M, the background information 92, and a light source information 93.

As described above, the 3D model 90M is a model including the mesh information M of the subject 90, the texture information T, and the depth information D. The 3D model 90M is generated based on a plurality of images obtained by capturing the subject 90 from different directions by the above-described imaging devices 70. Note that the subject 90 may be a single subject or a plurality of subjects. In addition, the subject may be stationary or moving. Furthermore, since the 3D model 90M generally has a large volume, the 3D model may be downloaded from an external server (not illustrated) connected to the information processing apparatus 10a via the Internet or the like as necessary and stored in the storage unit 43.

The background information 92 is video information as a background on which the 3D model 90M is arranged, which is captured by a camera or the like (not illustrated in FIG. 4). The background information 92 may be a moving image or a still image. In addition, the background information 92 may switch a plurality of different backgrounds at preset timing. Further, the background information 92 may be a CG.

The light source information 93 is a data file summarizing specifications of an illumination light source that illuminates the background information 92. Specifically, the light source information 93 includes an installation position and a lighting direction of the illumination light source. Note that the number of illumination light sources installed is not limited, and a plurality of light sources having the same specification or a plurality of light sources having different specifications may be installed.

The input/output controller 44 acquires, via a touch panel interface 47, operation information of a touch panel 50 stacked on a liquid crystal display 52 that displays information related to the information processing apparatus 10a. In addition, the input/output controller 44 displays video information on the liquid crystal display 52 via a display interface 48. In addition, the input/output controller 44 controls the operation of the imaging device 70 via a camera interface 49.

The communication controller 45 is connected to the mobile terminal 20 via wireless communication. The mobile terminal 20 receives the free viewpoint video generated by the information processing apparatus 10a and displays the free viewpoint video on the display device of the mobile terminal 20. As a result, the user of the mobile terminal 20 views the free viewpoint video.

Note that the information processing apparatus 10a may communicate with an external server (not illustrated) or the like via the communication controller 45 to acquire the 3D model 90M created at a place distant from the information processing apparatus 10a.

[1-5. Description of Functional Configuration of Information Processing Apparatus According to First Embodiment]

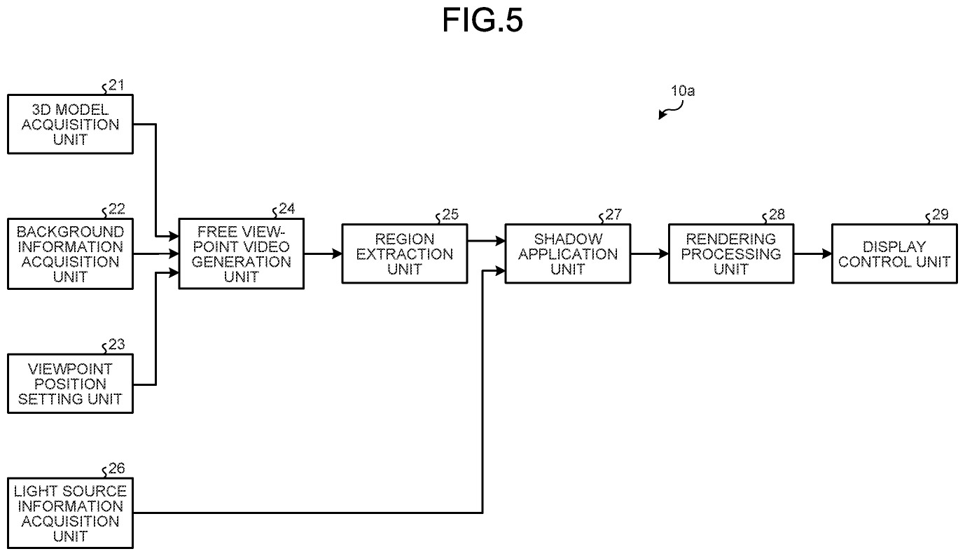

Next, a functional configuration of the information processing apparatus 10a will be described with reference to FIG. 5. FIG. 5 is a functional block diagram illustrating an example of a functional configuration of the information processing apparatus according to the first embodiment. The CPU 40 of the information processing apparatus 10a develops the control program P1 on the RAM 42 and operates the control program to implement each functional unit illustrated in FIG. 5.

The information processing apparatus 10a according to the first embodiment of the present disclosure superimposes the background information 92 captured by the camera on the 3D model 90M of the subject 90 to generate the free viewpoint video J in which the 3D model 90M is viewed from the free viewpoint V. In addition, the information processing apparatus 10a applies a shadow corresponding to the viewpoint position to the generated free viewpoint video J based on the light source information related to the background information 92. Moreover, the information processing apparatus 10a replays the generated free viewpoint video J. That is, the CPU 40 of the information processing apparatus 10a implements a 3D model acquisition unit 21, a background information acquisition unit 22, a viewpoint position setting unit 23, a free viewpoint video generation unit 24, a region extraction unit 25, a light source information acquisition unit 26, a shadow application unit 27, a rendering processing unit 28, and a display control unit 29 illustrated in FIG. 5 as functional units.

The 3D model acquisition unit 21 acquires the 3D model 90M of the subject 90 captured by the imaging device 70. Note that the 3D model acquisition unit 21 acquires the 3D model 90M from the storage unit 43, but is not limited thereto, and for example, may acquire the 3D model 90M from a server device (not illustrated) connected to the information processing apparatus 10a.

The background information acquisition unit 22 acquires the background information 92 for arranging the 3D model 90M. Note that the background information acquisition unit 22 acquires the background information 92 from the storage unit 43, but is not limited thereto, and may acquire the background information 92 from a server device (not illustrated) connected to the information processing apparatus 10a, for example.

The viewpoint position setting unit 23 sets the position of the free viewpoint V for viewing the 3D model 90M of the subject 90.

The free viewpoint video generation unit 24 generates the free viewpoint video J in which the 3D model 90M of the subject 90 superimposed on the background information 92 is viewed from the position of the free viewpoint V set by the viewpoint position setting unit 23. Note that the free viewpoint video generation unit 24 is an example of a generation unit in the present disclosure.

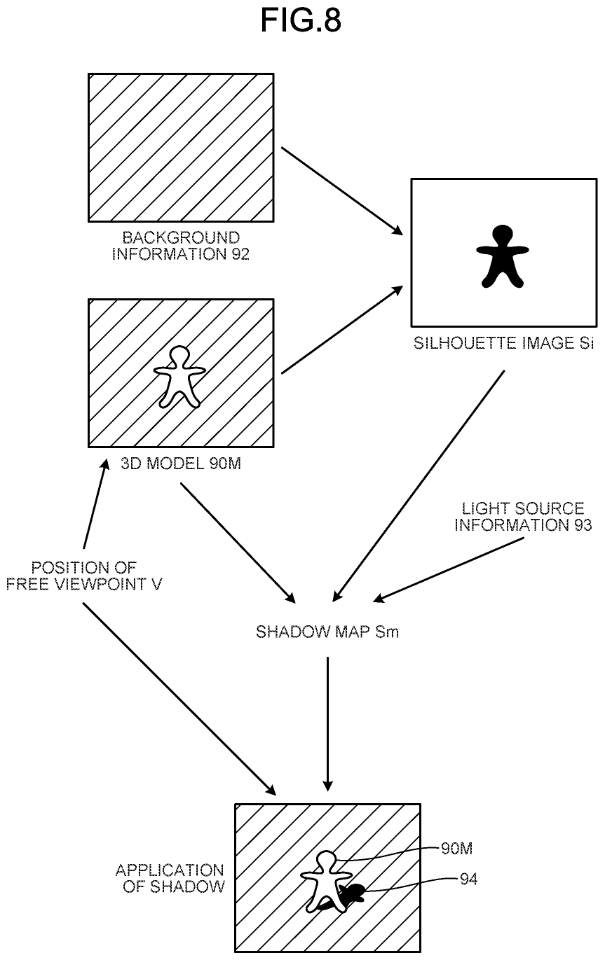

The region extraction unit 25 extracts a region of the 3D model 90M from the free viewpoint video J. Note that the region extraction unit 25 is an example of an extraction unit in the present disclosure. Specifically, the region extraction unit 25 extracts the region of the 3D model 90M by calculating a frame difference between the background information 92 and the free viewpoint video J. Details will be described later (see FIG. 8).

The light source information acquisition unit 26 acquires the light source information 93 indicating the position of the light source related to the background information 92 and the direction of the light beam emitted by the light source.

Based on the light source information 93 related to the background information 92, the depth information D (three-dimensional information) included in the 3D model 90M (3D object) of the subject 90, and the position of the free viewpoint V, the shadow application unit 27 generates the shadow 94 generated on the 3D model 90M according to the position of the free viewpoint V by the light source, and applies the generated shadow to the free viewpoint video J. More specifically, the shadow application unit 27 applies, to the 3D model 90M (3D object) according to the position (viewpoint position) of the free viewpoint V superimposed on the background information 92, the shadow 94 of the 3D model 90M generated based on the region of the 3D model 90M extracted by the region extraction unit 25 (extraction unit), the depth information D (three-dimensional information) included in the 3D model 90M, the light source information 93, and the position of the free viewpoint V.

The rendering processing unit 28 renders the free viewpoint video J.

The display control unit 29 causes, for example, the mobile terminal 20 to display the rendered free viewpoint video J.

[1-6. Description of Shadow Application Method]

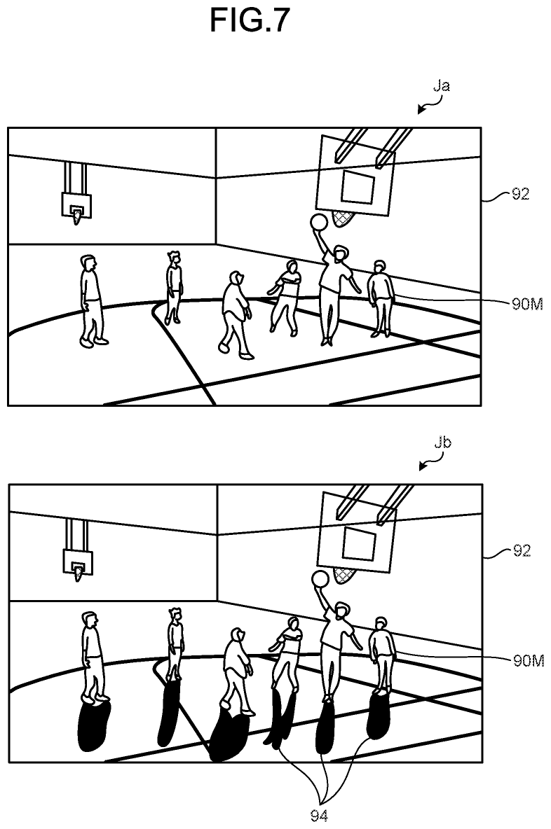

Next, a method in which the information processing apparatus 10a applies a shadow corresponding to the position of the free viewpoint V to the 3D model 90M of the subject 90 will be described with reference to FIGS. 6 and 7. FIG. 6 is a diagram illustrating a method in which the information processing apparatus according to the first embodiment applies a shadow to a 3D model. FIG. 7 is a diagram illustrating an example of a shadow applied to a 3D model by the information processing apparatus according to the first embodiment.

The shadow application unit 27 generates a shadow map Sm storing the depth information D of the 3D model 90M viewed from the light source based on the light source information 93.

In FIG. 6, it is assumed that the light source L is arranged at the position of (X1, Y1, Z1) and illuminates the direction of the 3D model 90M. Note that the light source L is a point light source, and the light beam emitted from the light source L spreads in the range of the radiation angle θ.

The shadow application unit 27 first generates the shadow map Sm storing the depth value of the 3D model 90M viewed from the light source L. Specifically, the distance between the light source L and the 3D model 90M is calculated based on the arrangement position of the 3D model 90M known in advance and (X1, Y1, Z1) which is the installation position of the light source L. Then, for example, the distance between the point E1 on the 3D model 90M and the light source L is stored in the point E1 of the shadow map Sm arranged according to the radiation direction of the light source L. Similarly, the distance between the point E2 on the 3D model 90M and the light source L is stored in the point F2 of the shadow map Sm, and the distance between the point E3 on the 3D model 90M and the light source L is stored in the point F3 of the shadow map Sm. In addition, when the light source L directly irradiates the floor surface on which the 3D model 90M is arranged, the distance between the point E4 on the floor surface and the light source L is stored in the point F4 of the shadow map Sm.

The shadow application unit 27 applies the shadow 94 of the 3D model 90M to a position corresponding to the free viewpoint V using the shadow map Sm generated in this manner.

Specifically, the shadow application unit 27 searches for a region hidden by the 3D model 90M as viewed from the light source L using the position of the free viewpoint V and the shadow map Sm. That is, the shadow application unit 27 compares the distance H1 between the point on the coordinate system XYZ and the light source L with the distance H2 stored in the shadow map Sm corresponding to the point on the coordinate system XYZ.

Then, when H1=H2, the shadow 94 is not applied to the point of interest. On the other hand, when H1>H2, the shadow 94 is applied to the point of interest. Note that H1<H2 is not satisfied.

For example, in FIG. 6, attention is paid on a point G1 that is an intersection of a straight line connecting the light source L and the point E1 and the floor surface. At this time, the distance H1 between the point G1 and the light source L is larger than the distance H2 between the light source L and the point E1, that is, the value stored in the point F1 of the shadow map Sm. Therefore, the shadow application unit 27 applies the shadow 94 to the position of the point G1 observed from the free viewpoint V.

Meanwhile, attention is paid to the point E4 on the floor surface. At this time, the distance H1 between the point E4 and the light source L is equal to the distance H2 between the light source L and the point E4, that is, the value stored in the point F4 of the shadow map Sm. Therefore, the shadow application unit 27 does not apply the shadow 94 to the position of the point E4 observed from the free viewpoint V.

In this manner, the shadow application unit 27 searches for a region where the shadow 94 of the 3D model 90M appears when observing the space in which the 3D model 90M is arranged from (X0, Y0, Z0), which is the setting position of the arbitrarily set free viewpoint V.

Note that the installation position of the light source L (X1, Y1, Z1) is not limited to one. That is, a plurality of point light sources may be installed. In this case, the shadow application unit 27 searches for an appearance region of the shadow 94 using the shadow map Sm generated for each light source.

In addition, the light source L is not limited to a point light source. That is, a surface light source may be installed. In this case, the shadow 94 is generated in orthographic projection by collimated light fluxes emitted from a surface light source, unlike generated in perspective projection by divergent light fluxes emitted from a point light source.

The shadow application unit 27 needs to efficiently generate the shadow map Sm in order to apply the shadow 94 at a high speed with a low calculation load. The information processing apparatus 10a according to the present embodiment efficiently generates the shadow map Sm by using an algorithm (see FIG. 8) to be described later. Note that the shadow 94 is provided by reducing the brightness of the region corresponding to the shadow 94. How much the brightness is lowered may be appropriately determined according to the intensity of the light source L, the brightness of the background information 92, and the like.

When the shadow application unit 27 applies the shadow 94, it is possible to give a realistic feeling to the free viewpoint video J as illustrated in FIG. 7.

A free viewpoint video Ja illustrated in FIG. 7 is a video in which the 3D model 90M is superimposed on the background information 92. At this time, the shadow 94 is not applied to the 3D model 90M. Therefore, in the free viewpoint video Ja, since the foreground, that is, the 3D model 90M looks floating, the video lacks realistic feeling.

On the other hand, in the free viewpoint video Jb, the shadow 94 is applied to the 3D model 90M superimposed on the background information 92. By applying the shadow 94 corresponding to the light source related to the background information 92 to the 3D model 90M in this manner, the free viewpoint video Jb can be made a video with realistic feeling.

[1-7. Description of Shadow Application Processing]

Next, a flow of shadow application processing performed by the shadow application unit 27 will be described with reference to FIG. 8. FIG. 8 is a diagram for explaining a flow of processing in which the information processing apparatus according to the first embodiment applies a shadow to a 3D model. Note that the processing illustrated in FIG. 8 is performed by the shadow application unit 27 and the rendering processing unit 28 of the information processing apparatus 10a.

The region extraction unit 25 calculates a frame difference between the background information 92 and the free viewpoint video J obtained by superimposing the 3D model 90M corresponding to the position of the free viewpoint V on a predetermined position of the background information 92. By this calculation, the silhouette image Si indicating the region of the 3D model 90M is obtained.

Subsequently, the shadow application unit 27 generates the shadow map Sm by using the region information of the 3D model 90M indicated by the silhouette image Si, the depth information D included in the 3D model 90M, and the light source information 93.

Next, the shadow application unit 27 applies the shadow 94 to the 3D model 90M using the position of the free viewpoint V and the shadow map Sm. Then, the rendering processing unit 28 draws an image in which the shadow 94 is applied to the 3D model 90M.

[1-8. Description of Flow of Processing Performed by Information Processing Apparatus According to First Embodiment]

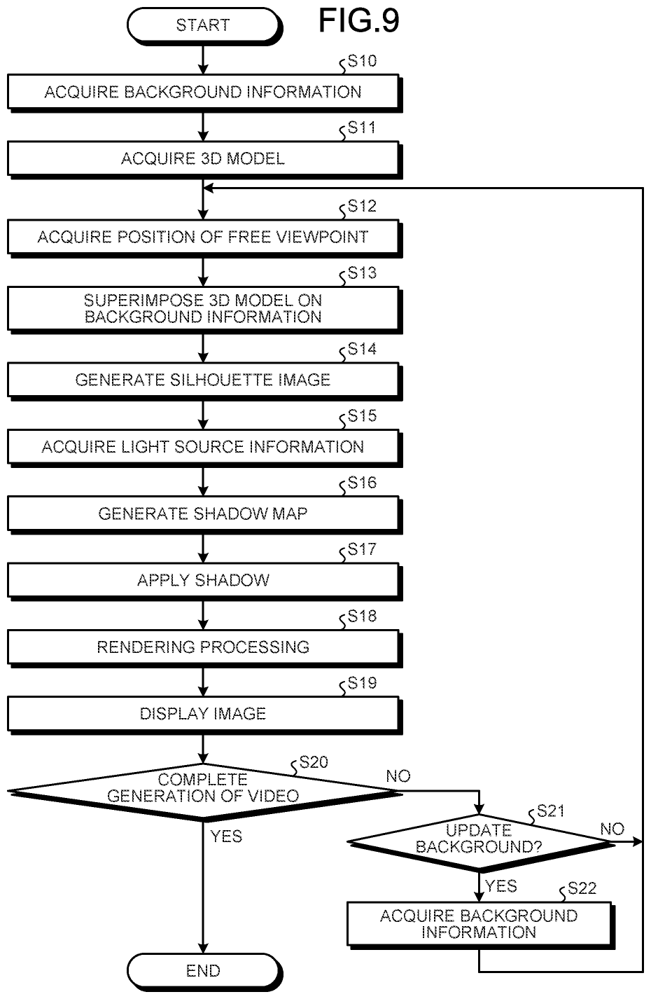

Next, a flow of a series of processing performed by the information processing apparatus 10a will be described with reference to FIG. 9. FIG. 9 is a flowchart illustrating an example of a flow of processing performed by the information processing apparatus according to the first embodiment.

The background information acquisition unit 22 acquires the background information 92 (Step S10).

The 3D model acquisition unit 21 acquires the 3D model 90M (Step S11).

The viewpoint position setting unit 23 acquires the position of the free viewpoint V for viewing the 3D model 90M of the subject 90 (Step S12).

The free viewpoint video generation unit 24 superimposes the 3D model 90M on the background information 92 and generates the free viewpoint video J observed from the position of the free viewpoint V (Step S13).

The shadow application unit 27 generates the silhouette image Si from the free viewpoint video J and the background information 92 (Step S14).

The light source information acquisition unit 26 acquires the light source information 93 indicating the position of the light source related to the background information 92 and the direction of the light beam emitted by the light source (Step S15).

Based on the light source information 93, the shadow application unit 27 generates the shadow map Sm storing the depth information D of the 3D model 90M viewed from the light source (Step S16).

The shadow application unit 27 applies the shadow 94 to the 3D model 90M in the free viewpoint video J (Step S17).

The rendering processing unit 28 renders the free viewpoint video J (Step S18).

The display control unit 29 causes, for example, the mobile terminal 20 to display the rendered free viewpoint video J (Step S19).

The free viewpoint video generation unit 24 determines whether the generation of the free viewpoint video J is completed (Step S20). When it is determined that the generation of the free viewpoint video J is completed (Step S20: Yes), the information processing apparatus 10a ends the processing of FIG. 9. On the other hand, when it is not determined that the generation of the free viewpoint video J is completed (Step S20: No), the process proceeds to Step S21.

The free viewpoint video generation unit 24 determines whether to change the background of the free viewpoint video J (Step S21). When it is determined that the background of the free viewpoint video J is to be changed (Step S21: Yes), the process proceeds to Step S22. On the other hand, when it is not determined to change the background of the free viewpoint video J (Step S21: No), the process returns to Step S12 and repeats the process of FIG. 9.

When Yes is determined in Step S21, the background information acquisition unit 22 acquires new background information 92 (Step S22). Thereafter, the processing returns to Step S12, and the processing of FIG. 9 is repeated.

[1-9. Effects of First Embodiment]

As described above, according to the information processing apparatus 10a of the first embodiment, the free viewpoint video generation unit 24 (generation unit) generates the free viewpoint video J of viewing the 3D model 90M (3D object) superimposed on the background information 92 from an arbitrary viewpoint position. Then, the shadow application unit 27 generates the shadow 94 of the light source generated on the 3D model 90M according to the viewpoint position based on the light source information 93 indicating the position of the light source related to the background information 92 and the direction of the light beam emitted by the light source, the depth information D (three-dimensional information) included in the 3D model 90M, and the viewpoint position, and applies the generated shadow to the free viewpoint video J.

As a result, the shadow 94 of the 3D model 90M according to the viewpoint position can be applied to the free viewpoint video J obtained by observing the 3D model 90M from the free viewpoint.

In addition, according to the information processing apparatus 10a of the first embodiment, the region extraction unit 25 (extraction unit) extracts the region of the 3D model 90M from the free viewpoint video J, and the shadow application unit 27 applies the shadow 94 to the 3D model 90M according to the position of the free viewpoint V superimposed on the background information 92, on the 3D model 90M generated based on the region of the 3D model 90M extracted by the region extraction unit 25, the three-dimensional information of the 3D model 90M, the light source information 93, and the viewpoint position.

As a result, since the region of the 3D model 90M can be easily extracted, the processing of applying the shadow 94 to the 3D model 90M can be efficiently performed with a low calculation load.

In addition, in the information processing apparatus 10a of the first embodiment, the 3D object is constructed by a plurality of images obtained by capturing the same subject from a plurality of viewpoint positions.

As a result, the free viewpoint video (image) J can easily be generated.

In addition, in the information processing apparatus 10a of the first embodiment, the 3D model 90M (3D object) has texture information according to the viewpoint position.

This makes it possible to render the 3D model 90M with high quality.

In addition, in the information processing apparatus 10a of the first embodiment, the 3D model 90M (3D object) is CG.

Thus, the shadow 94 can be applied regardless of the type of subject (live action or CG).

### 2. Second Embodiment

Next, an information processing apparatus 10b according to a second embodiment of the present disclosure will be described. The information processing apparatus 10b is an example in which the present disclosure is applied to a video effect called time freeze.

[2-1. Description of Time Freeze]

Before describing the present embodiment, first, time freeze will be described. Time freeze is a type of video effect in which the replay of the free viewpoint video J is paused, and the 3D model 90M in the free viewpoint video J is continuously viewed from different free viewpoints V in the paused state to emphasize the focused 3D model 90M.

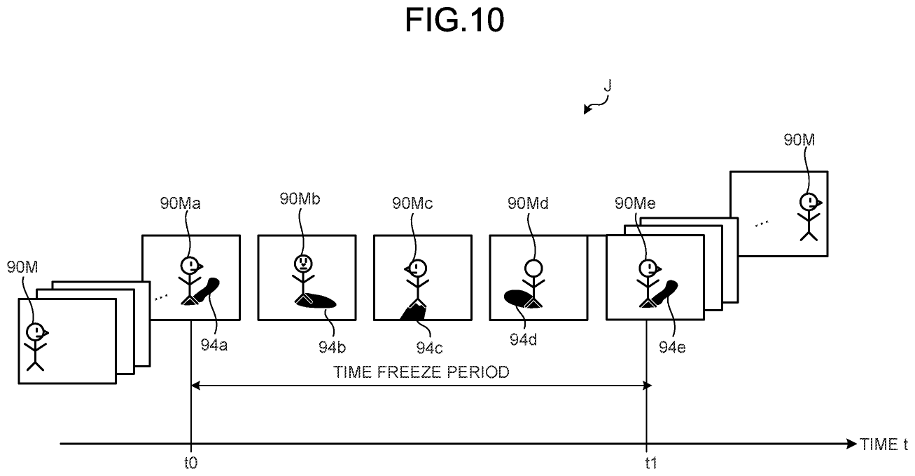

FIG. 10 is a diagram for describing a specific example of time freeze. In FIG. 10, before time t0, the video captured by the imaging device 70 is replayed. At this time, in a case where there is a light source in the background, a shadow 94 due to the light source is generated on the 3D model 90M.

The information processing apparatus 10b pauses the replay of the video at time t0. Then, the information processing apparatus 10b generates the free viewpoint video J while moving the free viewpoint V around the 3D model 90Ma by 360° between time t0 and time t1. Then, it is assumed that a light source illuminating the 3D model 90M is set in the background from time t0 to time t1.

That is, during the time freeze period, 3D models 90Ma, 90Mb, 90Mc, 90Md, and 90Me are sequentially generated as the free viewpoint video J. Then, a shadow of the light source related to the background information is applied to these 3D models. The applied shadow changes according to the position of the free viewpoint V like shadows 94a, 94b, 94c, 94d, and 94e illustrated in FIG. 10.

Then, when the time freeze is released at time t1, the light source is turned off, and replay of the video captured by the imaging device 70 is started again.

[2-2. Description of Shadow Intensity Control]

The information processing apparatus 10b has a function of adjusting the intensity of the shadow 94 applied to the 3D model 90M. For example, in a case where the 3D model 90M is illuminated with light using a new light source related to the background information in order to emphasize the 3D model 90M during the time freeze period, the presence or absence of a shadow suddenly changes between the video before the start of the time freeze and the video during the time freeze, and thus there is a possibility that an unnatural video is obtained. Similarly, there is a possibility that the joint between the video during the time freeze and the video after the time freeze is released becomes unnatural depending on the presence or absence of the shadow. The information processing apparatus 10b has a function of adjusting the intensity of the shadow 94 at such a joint between videos.

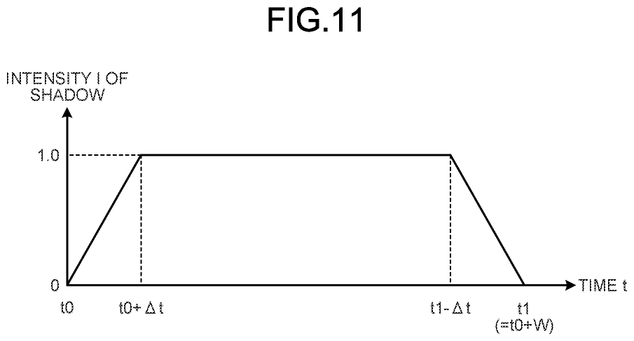

A state in which the information processing apparatus 10a controls the intensity of the shadow 94 will be described with reference to FIG. 11. FIG. 11 is a diagram illustrating an example of a table used for shadow intensity control when the information processing apparatus according to the second embodiment performs time freeze.

When the time freeze is performed, it is assumed that a required time W for performing the time freeze is set in advance. That is, in FIG. 11, in a case where the time freeze is started at time t=t0, the time freeze is released at time t=t0+W=t1.

The information processing apparatus 10b adjusts the intensity I of the shadow 94 applied to the 3D model 90M according to the table illustrated in FIG. 11. That is, at the start of time freeze, the intensity I of the shadow 94 is set to 0 (a state where there is no shadow). Then, the intensity of the shadow 94 is gradually adjusted to be strong with the lapse of time, and the intensity I of the shadow 94 is set to a normal intensity at time t=t0+Δt.

Thereafter, after time t=t1−Δt, the intensity I of the shadow 94 is gradually adjusted to be weak, and the intensity I of the shadow 94 is set to 0 at time t=t1, that is, at the time when the time freeze is released. Note that the value of Δt is appropriately set.

Note that, in FIG. 10, in a case where there is no change in the light source before and after time freeze, it is not necessary to adjust the intensity of the shadow 94 at a joint between videos. Therefore, it is desirable that the information processing apparatus 10b determine whether or not to adjust the intensity of the shadow 94 according to the environment in which the free viewpoint video J is generated, particularly, the set state of the light source to be set.

[2-3. Description of Functional Configuration of Information Processing Apparatus According to Second Embodiment]

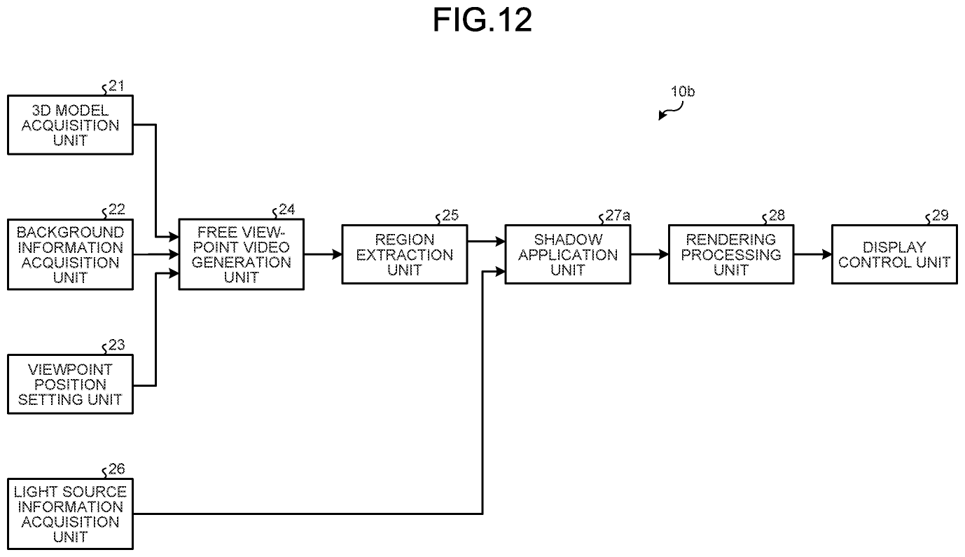

Next, a functional configuration of the information processing apparatus 10b will be described with reference to FIG. 12. FIG. 12 is a functional block diagram illustrating an example of a functional configuration of the information processing apparatus according to the second embodiment.

The information processing apparatus 10b has a configuration including a shadow application unit 27a instead of the shadow application unit 27 with respect to the functional configuration (see FIG. 5) of the information processing apparatus 10a. The shadow application unit 27a has a function of controlling the intensity of the shadow 94 to be applied, in addition to the function of the shadow application unit 27. The intensity is controlled based on the table illustrated in FIG. 11, for example. Note that the hardware configuration of the information processing apparatus 10b is the same as the hardware configuration of the information processing apparatus 10a (see FIG. 4).

[2-4. Description of Flow of Processing Performed by Information Processing Apparatus of Second Embodiment]

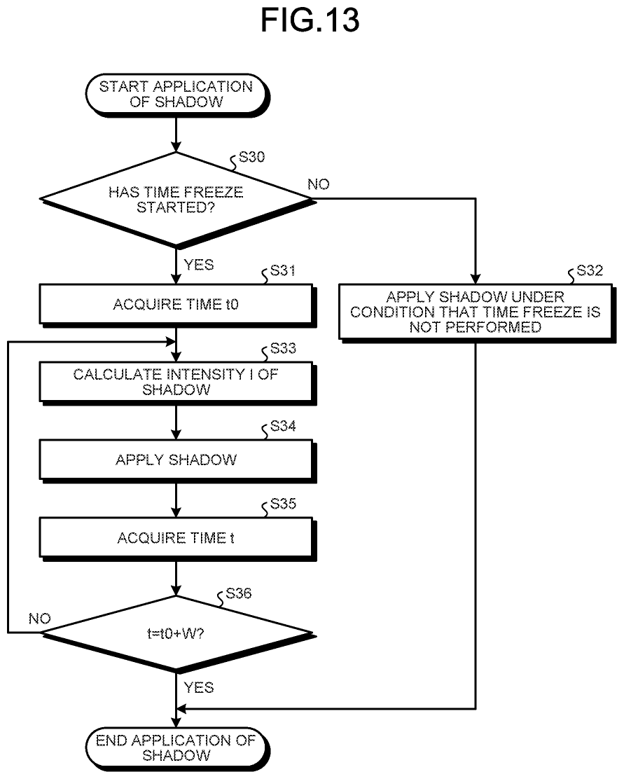

Next, a flow of processing performed by the information processing apparatus 10b will be described with reference to FIG. 13. FIG. 13 is a flowchart illustrating an example of a flow of processing when the information processing apparatus according to the second embodiment applies a shadow. Note that the flow of a series of processing performed by the information processing apparatus 10b is substantially the same as the flow of processing performed by the information processing apparatus 10a (see FIG. 9), and only the process of applying a shadow (Step S17 in FIG. 9) is different. Therefore, only a flow of processing for applying a shadow will be described with reference to FIG. 13.

The shadow application unit 27a determines whether the information processing apparatus 10b has started time freeze (Step S30). When it is determined that the information processing apparatus 10b has started the time freeze (Step S30: Yes), the process proceeds to Step S31. On the other hand, if it is not determined that the information processing apparatus 10b has started the time freeze (Step S30: No), the process proceeds to Step S32.

When the determination is No in Step S30, the shadow application unit 27a applies the shadow 94 to the 3D model 90M under the condition that the time freeze is not performed (Step S32). Thereafter, the shadow application unit 27a ends application of the shadow. Note that the processing performed in Step S32 is the same as the processing performed in Step S17 in FIG. 9.

When it is determined as Yes in Step S30, the shadow application unit 27a acquires time t0 at which time freeze has started (Step S31).

Subsequently, the shadow application unit 27a refers to the table in FIG. 11 and acquires the intensity I of the shadow corresponding to the current time (Step S33).

The shadow application unit 27a applies the shadow 94 having the intensity I to the 3D model 90M (Step S34). Note that the processing performed in Step S34 is the same as the processing performed in Step S17 in FIG. 9 except that the intensity I of the shadow 94 to be applied is different.

Subsequently, the shadow application unit 27a acquires the current time t (Step S35).

The shadow application unit 27a determines whether the current time t is equal to t0+W (Step S36). When it is determined that the current time t is equal to t0+W (Step S36: Yes), the shadow application unit 27a ends the application of the shadow. On the other hand, when it is not determined that the current time t is equal to t0+W (Step S36: No), the process returns to Step S33 and the above-described process is repeated.

[2-5. Effects of Second Embodiment]

As described above, in the information processing apparatus 10b according to the second embodiment, when starting or ending the generation of the free viewpoint video J, the shadow application unit 27a controls the intensity I of the shadow 94 of the 3D model 90M (3D object) generated based on the light source information 93 related to the background information 92.

As a result, it is possible to prevent the video from becoming unnatural due to discontinuity of the shadow 94 of the 3D model 90M (3D object) at the joint between the free viewpoint videos J.

In addition, in the information processing apparatus 10b according to the second embodiment, when switching between the video captured by the imaging device 70 and the free viewpoint video J, the shadow application unit 27a controls the intensity I of the shadow 94 of the 3D model 90M (3D object) generated based on the light source information 93.

As a result, it is possible to prevent the video from becoming unnatural due to discontinuity of the shadow 94 at the joint between the free viewpoint videos J.

In addition, in the information processing apparatus 10b according to the second embodiment, when starting or ending the generation of the free viewpoint video J, the shadow application unit 27a performs one of control to gradually increase the intensity I of the shadow 94 of the 3D model 90M (3D object) and control to gradually decrease the intensity I.

As a result, the intensity I of the shadow 94 applied to the 3D model 90M is gradually increased or decreased, so that the discontinuity of the shadow 94 is alleviated, whereby the naturalness of the free viewpoint video J can be improved.

In addition, in the information processing apparatus 10b according to the second embodiment, the shadow application unit 27a gradually increases the intensity I of the shadow 94 of the 3D model 90M (3D object) for a predetermined time after the free viewpoint video generation unit 24 (generation unit) starts generation of the free viewpoint video J, and gradually decreases the intensity I of the shadow 94 of the 3D model 90M from a predetermined time before the free viewpoint video generation unit 24 ends the generation of the free viewpoint video J.

As a result, the discontinuity of the shadow 94 applied to the 3D model 90M is alleviated, so that the naturalness of the free viewpoint video J can be improved.

In addition, in the information processing apparatus 10b according to the second embodiment, the free viewpoint video generation unit 24 (generation unit) generates the free viewpoint video J in which the 3D model 90M (3D object) in the free viewpoint video J is continuously viewed from different free viewpoints V in a state where the free viewpoint video J is paused.

As a result, since the intensity I of the shadow 94 of the 3D model 90M can be controlled at the start and end of time freeze, even in a case where discontinuity of the shadow 94 occurs due to the video effect, the discontinuity is alleviated by controlling the intensity I, so that the naturalness of the free viewpoint video J can be improved.

### 3. Third Embodiment

In the second embodiment, the example of controlling the intensity I of the shadow 94 at the start and end of time freeze has been described. However, the scene where it is desirable to control the intensity I of the shadow 94 is not limited to the time freeze scene. An information processing apparatus 10c according to a third embodiment of the present disclosure described below is an example in which shadow intensity control is applied to a scene where background information changes with time. Note that since the hardware configuration and the functional configuration of the information processing apparatus 10c are the same as those of the information processing apparatus 10b described in the second embodiment, the description thereof will be omitted.

[3-1. Description of Scene in which Background Information Changes]

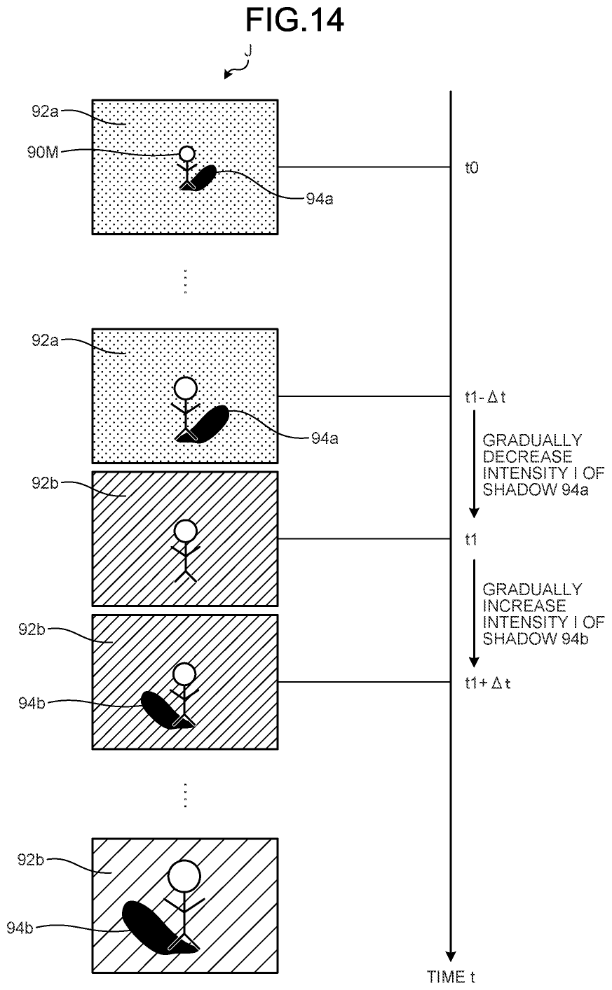

FIG. 14 is a diagram illustrating an example of a scene in which background information changes. FIG. 14 is an example of a free viewpoint video J representing a scene in which the 3D model 90M gradually approaches the free viewpoint V from time t0 with time.

In particular, in the example of FIG. 14, at time t1, the background information 92 is switched from first background information 92a to second background information 92b. In addition, the position of the light source changes from time t0 to time t1 and after time t1. Therefore, a shadow 94a applied to the 3D model 90M between time t0 and time t1 and a shadow 94b applied to the 3D model 90M after time t1 extend in different directions.

In a scene where the background information 92 changes in this manner, the information processing apparatus 10c controls the intensity I of the shadow before and after time t1 at which the scene is switched.

That is, the intensity I of the shadow 94a of the 3D model 90M is gradually decreased between time t1−Δt and t=t1. At time t1, the shadow 94a disappears at timing when the background information 92 is switched from the first background information 92a to the second background information 92b.

Then, between time t1 and time t1+Δt, the intensity I of the shadow 94b of the 3D model 90M is gradually increased. As a result, since the shadow is not discontinuously switched before and after time t1 at which the background information 92 is switched, a natural free viewpoint video J can be generated. Note that the method for adjusting the intensity I of the shadow is the same as that described in the second embodiment, and thus the description thereof will be omitted.

In addition, in a case where the position of the light source does not change at time t1, the state of the shadow 94a applied before time t1 is maintained even after time t1. In this case, the intensity I of the shadow 94 is not controlled.

[3-2. Effects of Third Embodiment]

As described above, in the information processing apparatus 10c according to the third embodiment, when switching between the free viewpoint video J generated based on the first background information 92a and the free viewpoint video J generated based on the second background information 92b, the shadow application unit 27a controls the intensity I of the shadow 94a of the 3D model 90M (3D object) generated based on the light source information 93 related to the first background information 92a and the intensity I of the shadow 94b of the 3D model 90M generated based on the light source information 93 related to the second background information 92b.

As a result, the unnaturalness of the joint at the switching portion (background change portion) of the free viewpoint video J can be alleviated.

Note that the effects described in the present specification are merely examples and are not limited, and other effects may be provided. In addition, the embodiments of the present disclosure are not limited to the above-described embodiments, and various modifications can be made without departing from the gist of the present disclosure.

For example, the present disclosure can also have the following configurations.

(1)

An information processing apparatus including:

a generation unit that generates a free viewpoint video in which a 3D object superimposed on background information is viewed from a viewpoint position that is arbitrary; and

a shadow application unit that generates a shadow generated on the 3D object according to the viewpoint position by a light source based on light source information indicating a position of the light source related to the background information and a direction of a light beam emitted by the light source, three-dimensional information of the 3D object, and the viewpoint position, and applies the shadow generated to the free viewpoint video.

(2)

The information processing apparatus according to (1), wherein

the shadow application unit controls intensity of a shadow of the 3D object generated based on the light source information related to the background information when starting or ending generation of the free viewpoint video.

(3)

The information processing apparatus according to (1) or (2), wherein

the shadow application unit controls the intensity of the shadow of the 3D object generated based on the light source information when switching between a video captured by an imaging device and the free viewpoint video.

(4)

The information processing apparatus according to (1), wherein

the shadow application unit controls intensity of a shadow of the 3D object generated based on the light source information related to first background information and intensity of a shadow of the 3D object generated based on the light source information related to second background information when switching between the free viewpoint video generated based on the first background information and the free viewpoint video generated based on the second background information.

(5)

The information processing apparatus according to any one of (2) to (4), wherein

the shadow application unit performs one of control of gradually increasing the intensity of the shadow of the 3D object and control of gradually decreasing the intensity of the shadow when starting or ending the generation of the free viewpoint video.

(6)

The information processing apparatus according to any one of (2) to (5), wherein

the shadow application unit

gradually increases the intensity of the shadow of the 3D object for a predetermined time after the generation unit starts the generation of the free viewpoint video, and

gradually decreases the intensity of the shadow of the 3D object from a predetermined time before the generation unit ends the generation of the free viewpoint video.

(7)

The information processing apparatus according to any one of (1) to (6), further including

an extraction unit that extracts a region of the 3D object from the free viewpoint video, wherein

the shadow application unit

applies a shadow of the 3D object generated based on the region of the 3D object extracted by the extraction unit, the three-dimensional information of the 3D object, the light source information, and the viewpoint position to the 3D object superimposed on the background information and corresponding to the viewpoint position.

(8)

The information processing apparatus according to any one of (1) to (3), wherein

the generation unit generates a free viewpoint video in which a 3D object in the free viewpoint video is continuously viewed from different free viewpoints in a state where the free viewpoint video is paused.

(9)

The information processing apparatus according to any one of (1) to (8), wherein

the 3D object is constructed by a plurality of images obtained by capturing an identical subject from a plurality of viewpoint positions.

(10)

The information processing apparatus according to any one of (1) to (9), wherein

the 3D object has texture information corresponding to a viewpoint position.

(11)

The information processing apparatus according to any one of (1) to (10), wherein

the 3D object is computer graphics, CG.

(12)

An information processing method including:

a generating step of generating a free viewpoint video in which a 3D object superimposed on background information is viewed from a viewpoint position that is arbitrary; and

a shadow applying step of generating a shadow generated on the 3D object according to the viewpoint position by a light source based on light source information indicating a position of the light source related to the background information and a direction of a light beam emitted by the light source, three-dimensional information of the 3D object, and the viewpoint position, and applying the shadow generated to the free viewpoint video.

(13)

A program causing a computer to function as:

a generation unit that generates a free viewpoint video in which a 3D object superimposed on background information is viewed from a viewpoint position that is arbitrary; and

a shadow application unit that generates a shadow generated on the 3D object according to the viewpoint position by a light source based on light source information indicating a position of the light source related to the background information and a direction of a light beam emitted by the light source, three-dimensional information of the 3D object, and the viewpoint position, and applies the shadow generated to the free viewpoint video.

### REFERENCE SIGNS LIST

10a, 10b INFORMATION PROCESSING APPARATUS
20 MOBILE TERMINAL
21 3D MODEL ACQUISITION UNIT
22 BACKGROUND INFORMATION ACQUISITION UNIT
23 VIEWPOINT POSITION SETTING UNIT
24 FREE VIEWPOINT VIDEO GENERATION UNIT (GENERATION UNIT)
25 REGION EXTRACTION UNIT (EXTRACTION UNIT)
26 LIGHT SOURCE INFORMATION ACQUISITION UNIT
27, 27a SHADOW APPLICATION UNIT
28 RENDERING PROCESSING UNIT
29 DISPLAY CONTROL UNIT
70, 70a, 70b, 70c IMAGING DEVICE
72, 72a, 72b VIRTUAL CAMERA
90 SUBJECT
90M, 90Ma, 90Mb, 90Mc, 90Md, 90Me 3D MODEL (3D OBJECT)
92 BACKGROUND INFORMATION
92a FIRST BACKGROUND INFORMATION
92b SECOND BACKGROUND INFORMATION
93 LIGHT SOURCE INFORMATION
94 SHADOW
D DEPTH INFORMATION (THREE-DIMENSIONAL INFORMATION)
H1, H2 DISTANCE
J, Ja, Jb, J1, J2 FREE VIEWPOINT VIDEO
L LIGHT SOURCE
M MESH INFORMATION
Si SILHOUETTE IMAGE
Sm SHADOW MAP
T, Ta, Tb TEXTURE INFORMATION
V, V1, V2 FREE VIEWPOINT

1. An information processing apparatus including:
a generation unit that generates a free viewpoint video in which a 3D object superimposed on background information is viewed from a viewpoint position that is arbitrary; and
a shadow application unit that generates a shadow generated on the 3D object according to the viewpoint position by a light source based on light source information indicating a position of the light source related to the background information and a direction of a light beam emitted by the light source, three-dimensional information of the 3D object, and the viewpoint position, and applies the shadow generated to the free viewpoint video.

2. The information processing apparatus according to claim 1, wherein
the shadow application unit controls intensity of a shadow of the 3D object generated based on the light source information related to the background information when starting or ending generation of the free viewpoint video.

3. The information processing apparatus according to claim 2, wherein
the shadow application unit controls the intensity of the shadow of the 3D object generated based on the light source information when switching between a video captured by an imaging device and the free viewpoint video.

4. The information processing apparatus according to claim 1, wherein
the shadow application unit controls intensity of a shadow of the 3D object generated based on the light source information related to first background information and intensity of a shadow of the 3D object generated based on the light source information related to second background information when switching between the free viewpoint video generated based on the first background information and the free viewpoint video generated based on the second background information.

5. The information processing apparatus according to claim 2, wherein
the shadow application unit performs one of control of gradually increasing the intensity of the shadow of the 3D object and control of gradually decreasing the intensity of the shadow when starting or ending the generation of the free viewpoint video.

6. The information processing apparatus according to claim 5, wherein
the shadow application unit
gradually increases the intensity of the shadow of the 3D object for a predetermined time after the generation unit starts the generation of the free viewpoint video, and
gradually decreases the intensity of the shadow of the 3D object from a predetermined time before the generation unit ends the generation of the free viewpoint video.

7. The information processing apparatus according to claim 1, further including
an extraction unit that extracts a region of the 3D object from the free viewpoint video, wherein
the shadow application unit
applies a shadow of the 3D object generated based on the region of the 3D object extracted by the extraction unit, the three-dimensional information of the 3D object, the light source information, and the viewpoint position to the 3D object superimposed on the background information and corresponding to the viewpoint position.

8. The information processing apparatus according to claim 1, wherein
the generation unit generates a free viewpoint video in which a 3D object in the free viewpoint video is continuously viewed from different free viewpoints in a state where the free viewpoint video is paused.

9. The information processing apparatus according to claim 1, wherein
the 3D object is constructed by a plurality of images obtained by capturing an identical subject from a plurality of viewpoint positions.

10. The information processing apparatus according to claim 9, wherein
the 3D object has texture information corresponding to a viewpoint position.

11. The information processing apparatus according to claim 1, wherein
the 3D object is computer graphics, CG.

12. An information processing method including:
a generating step of generating a free viewpoint video in which a 3D object superimposed on background information is viewed from a viewpoint position that is arbitrary; and
a shadow applying step of generating a shadow generated on the 3D object according to the viewpoint position by a light source based on light source information indicating a position of the light source related to the background information and a direction of a light beam emitted by the light source, three-dimensional information of the 3D object, and the viewpoint position, and applying the shadow generated to the free viewpoint video.

13. A program causing a computer to function as:
a generation unit that generates a free viewpoint video in which a 3D object superimposed on background information is viewed from a viewpoint position that is arbitrary; and
a shadow application unit that generates a shadow generated on the 3D object according to the viewpoint position by a light source based on light source information indicating a position of the light source related to the background information and a direction of a light beam emitted by the light source, three-dimensional information of the 3D object, and the viewpoint position, and applies the shadow generated to the free viewpoint video.
